(19) United States
(12) Patent Application Publication
(10) Pub. No.: US 2008/0174839 A1
(43) Pub. Date: Jul. 24, 2008

(54) Full color optical image scanning

(76) Inventor: Kevin Youngers, Greeley, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/626,800

(22) Filed: Jan. 24, 2007

(51) Int. Cl. H04N 1/46

(52) U.S. Cl. 358/505

(57) ABSTRACT

A full color digital representation of an image is generated. For each location of an image, a number of color components of the image are optically scanned, and a grayscale component of the image is optically scanned. An additional color component of the image is generated at each location from the color components optically scanned and from the grayscale component optically scanned. The color components optically scanned and the additional color component generated together describe the image at each location.

### BACKGROUND

Scanning is the process of generating a digital representation of a hardcopy image, such as an image printed on media like paper. Scanning involves outputting light onto the hardcopy image, and detecting the light as reflected by the image. This process is performed for each of a number of locations on the image. Full color scanning generally involves sensing values for all color components on the locations of a hardcopy image. For example, a red value, a green value, and a blue value may together describe the color at a given location of an image.

A difficulty with full color scanning, however, is that not all the color components are equally detectable. For instance, some optical sensors are less responsive to blue light than they are to red and green light. To overcome this problem, scanning speed may be decreased so that blue light is adequately detected, but this decreases overall scanning performance. The size of the blue sensor may be increased, but this adds cost to the scanning device. Other proposed solutions have similar drawbacks.

### BRIEF DESCRIPTION OF THE DRAWINGS

FIG. 1 is a diagram of a representative hardcopy image that can be scanned in full color, according to an embodiment of the invention.

FIG. 2 is a diagram depicting how a full color digital representation can be obtained at a location without directly optically sensing all the color components at the location, according to an embodiment of the invention.

FIG. 3 is a flowchart of a method, according to an embodiment of the invention.

FIG. 4 is a rudimentary diagram of a scanning device, according to an embodiment of the invention.

### DETAILED DESCRIPTION

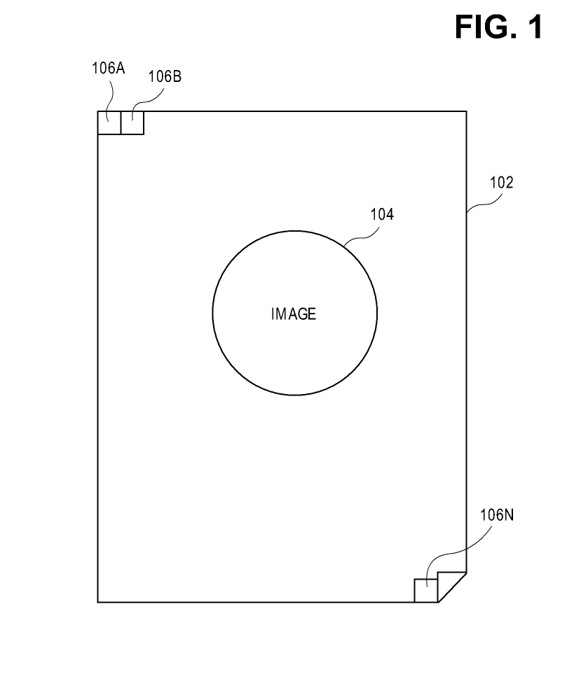

FIG. 1 shows a media sheet 102 having an image 104 that may be scanned in full color, according to an embodiment of the invention. The media sheet 102 may be a sheet of paper, for instance. In general, insofar as the sheet 102 is a physical piece of media, the image 104 can be referred to as a hardcopy image. Embodiments of the invention are thus concerned with scanning media sheet 102, inclusive of the image 104, to generate a full color digital representation of the image 104 in particular. Such a digital representation includes data in an electronic form that may be manipulated by a computer, for instance.

The media sheet 102, inclusive of the image 104, is logically divisible into a number of locations 106A, 106B, . . . , 106N, collectively referred to as the locations 106. The number of locations 106 is generally dependent on the resolution of the scanning device used to scan the media sheet 102. For example, a scanning device having a resolution of 300 lines per inch (LPI) may be able to detect locations on the media sheet 102 that are as small as 1/300 of an inch along a given dimension. Thus, the locations 106 are not inherent to the media sheet 102 or the image 104, but rather are a function of the scanning process employed to generate a digital representation thereof.

It is noted that the locations 106 as a whole are accurately on the media sheet, such that just a portion of the locations 106 represent the image 104. However, the terminology “locations on the image” is nevertheless used for descriptive convenience. Such locations can include all the locations on the media sheet 102 encompassing the image 104, and not just the locations where the image 104 is located, as can be appreciated by those of ordinary skill within the art.

Each of the locations 106 when scanned has a number of color components, where the color components together are completely descriptive of the color of the location in question. For example, typically a full color digital representation of an image includes a value for a red color component, a value for a green color component, and a value for a blue color component of each location on the image. These red, green, and blue values for each location fully describe the color of that location. The red, green, and blue values for all the locations together are the full color digital representation of the image.

Within the prior art, typically each of these color components is individually detected using an optical sensor, as has been alluded to in the background. Thus, for each location of an image, a red value is optically detected, a green value is optically detected, and a blue value is optically detected. However, as has been noted in the background, some colors of light, such as blue light, are more difficult to detect than other colors of light with certain types of optical sensors, such as charge-coupled devices (CCD's). Embodiments of the invention overcome such problems, as is now described.

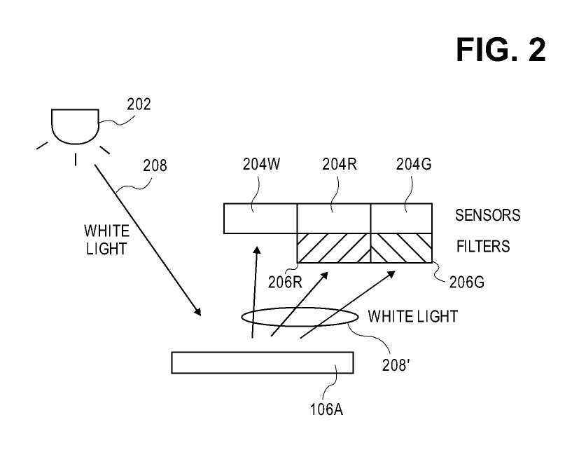

FIG. 2 shows how color component values for a given location 106A can be obtained without optically detecting all the color components at the location 106A, according to an embodiment of the invention. A white light source 202, such as a light-emitting diode (LED) that emits white light, outputs white light 208 against the location 106A. The light 208 is white in that it substantially wavelengths of visible light substantially dispersed across the entire visible spectrum. The white light 208 is reflected off the location 106A, as the white light 208′.

Optical sensors 204R, 204G, and 204W, collectively referred to as the optical sensors 204, differently sense or detect the white light 208′ reflected by the location 106A. The optical sensors 204 may be charge-coupled devices (CCD's), or other types of optical sensors. The optical sensor 204W detects a grayscale response of the white light 208′, which may be referred to as the gray component, or gray or grayscale value, of the location 106A. For instance, if just the optical sensor 204W were used to scan all the locations 106, the resulting digital representation would be a grayscale representation of the image, as opposed to a full color representation of the image.

The grayscale response may be non-restrictively defined as follows. First, it may be defined as a series of achromatic tones having varying proportions of white and black, to give a full range of grays between white and black. Second, it may be considered as a series of shades from white to black.

Optical filters 206R and 206G particularly filter the white light 208′ before the white light 208′ is detected or sensed by the optical sensors 204R and 204G. The optical filter 206R substantially permits just red light to reach the optical sensor 204R, whereas the optical filter 206G substantially permits just green light to reach the optical sensor 204G. Stated another way, the optical filter 206R substantially permits just red frequencies of the white light 208′ to pass, whereas the optical filter 206G substantially permits just green frequencies of the white light 208′ to pass.

Therefore, the optical sensor 204R detects a red response of the white light 208′, which may be referred to as the red component, or a red value, of the location 106A. Likewise, the optical sensor 204G detects a green response of the white light 208′, which may be referred to as the green component, or a green value, of the location 106A. Together with the grayscale response detected by the optical sensor 204W, then, three different components are scanned for the location 106A: a red component, a green component, and a gray component.

By themselves, the red, green, and gray components are insufficient to provide a full color digital representation at the location 106A. In particular, a blue component is missing. Rather than directly optically sensing the blue component at the location 106A, as in the prior art, one embodiment of the invention instead generates, or calculates, the blue component from the red, green, and gray components that have been directly optically scanned.

For instance, in one embodiment, the following equation may be used to generate the blue component at the location 106A without actually directly optically sensing the blue component using an optical sensor:

BLUE=c*GRAY−RED−GREEN

In this equation, GRAY is the value of the gray component that has been optically scanned by the sensor 204W, RED is the value of the red component that has been optically scanned by the sensor 204R, and GREEN is the value of the green component that has been optically scanned by the sensor 204G. c is a constant, which in one embodiment can be three, for instance. Therefore, the value of the blue component, BLUE, is calculated without having to actually be optically scanned. In other embodiments, c may be empirically determined to produce the most accurate blue values.

Other types of equations and transformations may be employed that are more sophisticated than the equation that has been presented in the previous paragraph, as can be appreciated by those of ordinary skill within the art. The above equation represents the ideal scenario in which there is no noise or crosstalk among the sensors 204, ambient light effects, and so on. Where noise, crosstalk, ambient noise, and so on, are problematic, empirically tested transformations may be employed to generate the blue component from the gray, red, and green color components to reduce these effects.

Furthermore, the embodiment of FIG. 2 has been described in which the gray component and two particular color components—red and green—are directly optically sensed, and an additional color component—blue—is generated from the gray component and these two color components. However, in other embodiments of the invention, which of the color components are directly optically detected and which are generated can vary. For example, the gray component and the red and blue color components may instead be directly optically sensed, and the green color component may instead be generated from the gray component and these two color components.

The exposure times of the optical sensors 204 may also vary. In the example of FIG. 2, for instance, the red sensor 204R and the green sensor 204G may be turned on for one millisecond to properly detect the red and green components at the location 106A. By comparison, the gray sensor 204W may be turned on for just a half a millisecond to properly detect the gray component at the location 106A. The exposure times of the optical sensors 204 may vary from these examples as well.

It is noted that the embodiment of FIG. 2 differs from conventional approaches to full-color scanning. Typically, for instance, a three sensor or a four sensor configuration may be employed as follows. For a three sensor configuration, the three sensors detect the red, green, and blue color components, respectively, whereas for a four sensor configuration, the four sensors detect the red, green, and blue color components and the grayscale component, respectively. The former approach is less expensive to implement, since there is one less sensor, while the latter approach is more expensive to implement but provides for faster grayscale scanning, since there is a dedicated sensor for gray. By comparison, the embodiment of FIG. 2 is less expensive to implement, since it just has three sensors, but still provides for faster grayscale scanning, since there is still a dedicated sensor for gray.

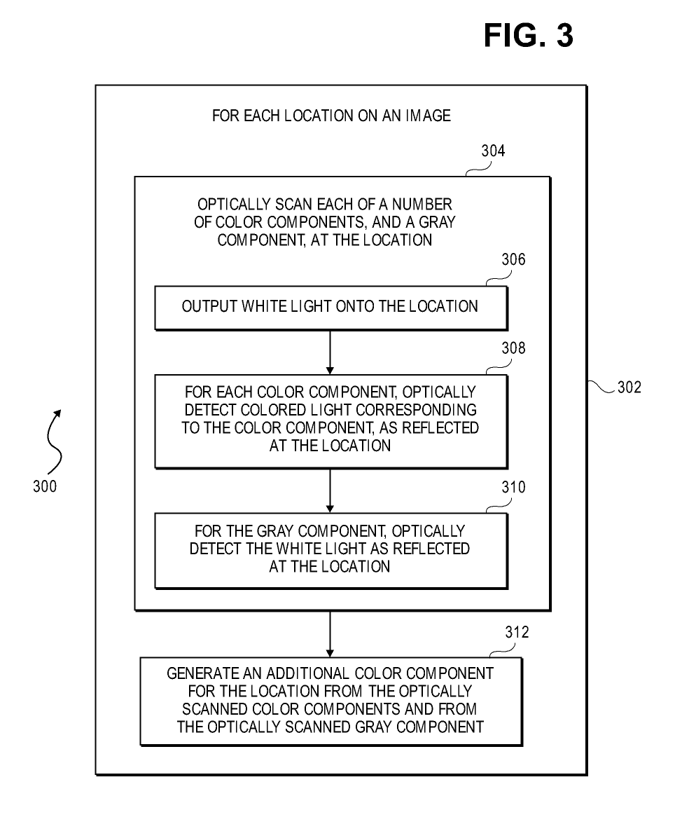

FIG. 3 shows a method 300 for optically scanning a full color digital representation of a hardcopy image consistent with FIG. 2, according to an embodiment of the invention. The following is performed for each location of the hardcopy image (302). First, a number of color components are each optically scanned, as well as a gray component, at the location in question (304). For example, the red and green color components may be optically scanned, yielding red and green values at the location. Optically scanning the gray component likewise yields a gray value at the location.

Such optical scanning may be achieved in one embodiment as follows. White light is output onto the location in question (308). Thereafter, for each color component, colored light corresponding to the color component, as reflected at the location, is detected (308). For example, an optical sensor with a green optical filter thereover may be turned on for a predetermined length of time to generate the green value for the location, and an optical sensor with a red optical filter thereover may be turned on for the same or different length of time to generate the red value for the location. Thus, the colored light in each case results from the white light being reflected at the location, and then passing through a correspondingly colored filter before reaching a given optical sensor.

For the gray component at the location, the white light as reflected by the location is optically detected (310), to yield the gray value for the location. An optical sensor with no optical filter thereover may be turned on for the same or different length of time to generate this gray value for the location. The end result is that there are color component values and a gray component value for the location in question. However, these values are insufficient to fully describe the color at the location of the image.

Therefore, an additional color component is generated for the location from the optically scanned color components and from the optically scanned gray component (312). For instance, where red, green, and gray components have been optically scanned, a blue component may be generated as has been described in relation to FIG. 2. The end result is that a sufficient number of color component values—such as red, green, and blue values—to fully describe the color at the location in question is obtained or acquired. Two of these three values, the red and green values, are directly optically scanned. The third value, the blue value, is generated and is not directly optically scanned.

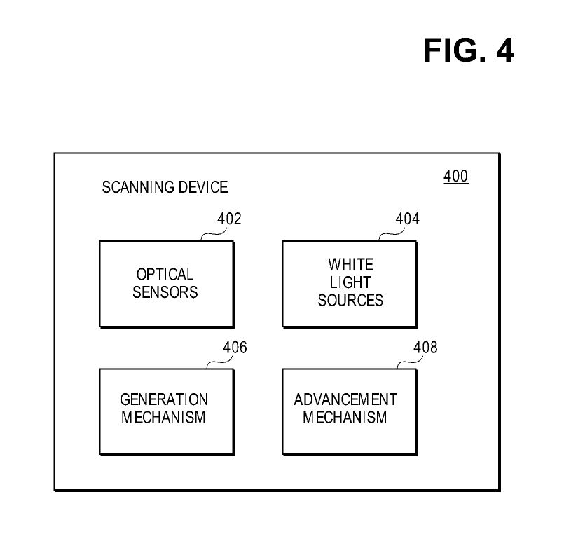

FIG. 4 shows a rudimentary block diagram of a scanning device 400, according to an embodiment of the invention. The scanning device 400 is depicted in FIG. 4 as including optical sensors 402, one or more white light sources 404, a generation mechanism 406, and an advancement mechanism 408. As can be appreciated by those of ordinary skill within the art, the scanning device 400 may include other components, in addition to and/or in lieu of those depicted in FIG. 4.

The optical sensors 402 optically sense a gray component of an image, and color components of the image, but do not optically sense all the color components needed to describe the image in full color in one embodiment of the invention. The optical sensors 402 may thus include a sensor for detecting grayscale values, a sensor for detecting red values, and a sensor for detecting green values, but not a sensor for detect blue values, for instance. The optical sensors 402 may be or include the sensors 204 of FIG. 2, and may be CCD's, or different types of optical sensors.

The white light sources 404 output white light inclusive of substantially all the visible light wavelengths. The white light is output incident to locations on an image, as has been described in relation to FIG. 2. Such white light is then detected by the optical sensors 402. In the case of the optical sensors 402 corresponding to the color components, the white light first passes through corresponding color filters. The white light sources 404 may be or include the white light source 202 of FIG. 2, and may be LED's or different types of white light sources.

The generation mechanism 406 may be implemented in hardware, software, or a combination of hardware and software. The generation mechanism 406 generates color component values for the image from the optically scanned gray and color component values of the image so that a full description of the image can be provided within a resulting digital representation. For example, as has been described, where gray, red, and green values are directly optically detected for each location of an image, the blue value for each location may be generated from these optically detected values.

The advancement mechanism 406 may be or include one or more motors. The advancement mechanism 406 moves the media sheet 102 in relation to the optical sensors 402 and/or the white light sources 404, so that each location on the media sheet 102 may be optically scanned. For example, the optical sensors 402 may be arranged in a linear array corresponding in length to the short side of a typical letter-sized sheet of media. A given line, or swath, of the sheet may be optically scanned by the optical sensors 402, and then the advancement mechanism 406 may advance the sheet so that the next line or swath is optically scanned. This process can be repeated until the entire sheet has been optically scanned.

We claim:

1. A method for generating a full color digital representation of an image, comprising:
for each location of a plurality of locations on the image,
optically scanning each of a plurality of color components of the image at the location;
optically scanning a grayscale component of the image at the location; and,
generating an additional color component of the image at the location from the color components optically scanned and from the grayscale component optically scanned,
wherein the color components optically scanned and the additional color component generated together describe the image at each location.

2. The method of claim 1, wherein optically scanning each of the color components of the image at the location and optically scanning the grayscale component of the image at the location comprise:
outputting white light onto the location of the image;
for each of the color components of the image, optically detecting colored light corresponding to the color component as reflected at the location of the image; and,
for the grayscale component of the image, optically detecting the white light as reflected at the location of the image.

3. The method of claim 2, wherein, for each of the color components of the image, optically detecting the colored light corresponding to the color component as reflected at the location of the image comprises optically detecting the white light as reflected at the location of the image after the white light has passed through a color filter corresponding to the color component.

4. The method of claim 2, wherein, for each of the color components of the image, optically detecting the colored light corresponding to the color component as reflected at the location of the image comprises turning on an optical sensor corresponding to the color component for a first predetermined length of time.

5. The method of claim 4, wherein, for the grayscale component of the image, optically detecting the white light as reflected at the location of the image comprises turning on an optical sensor corresponding to the grayscale component for a second predetermined length of time different than the first predetermined length of time.

6. The method of claim 5, wherein,
for each of the color components of the image, optically detecting the color light corresponding to the color component as reflected at the location of the image yields a value for the color component at the location of the image, and
for the grayscale component of the image, optically detecting the white light as reflected at the location of the image yields a value for the grayscale component at the location of the image.

7. The method of claim 5, wherein the first predetermined length of time is twice the second predetermined length of time.

8. The method of claim 1, wherein generating the additional color component of the image at the location comprises subtracting values for the color components of the image at the location from a product of a constant and a value for the grayscale component of the image at the location.

9. The method of claim 8, wherein the constant is three.

10. The method of claim 1, wherein the color components that are optically scanned are red and green, and the additional color component that is generated from the color components that are optically scanned and from the grayscale component that is optically scanned is blue.

11. The method of claim 1, wherein the color components that are optically scanned are red and blue, and the additional color component that is generated from the color components that are optically scanned and from the grayscale component that is optically scanned is green.

12. An optical scanning device comprising:
a plurality of optical sensors corresponding to a plurality of color components of an image and to a grayscale component of the image; and,
a mechanism to generate an additional color component from the color components of the image and from the grayscale component of the image,
such that a full color digital representation of the image is acquirable.

13. The optical scanning device of claim 12, wherein the mechanism is a first mechanism, the optical scanning device further comprising:
one or more white light sources to output white light against the image for detection by the optical sensors; and,
a second mechanism to advance media having the image to be optically scanned in relation to the optical sensors.

14. The optical scanning device of claim 12, further comprising, for each of the optical sensors corresponding to a color component, a colored filter placed in front of the optical sensor and having a color corresponding to the color component.

15. The optical scanning device of claim 12, wherein the mechanism is to generate the additional color component from the color components of the image and from the grayscale component of the image by subtracting values for the color components of the image from a product of a constant and a value for the grayscale component of the image.

16. The optical scanning device of claim 12, wherein the color components to which the optical sensors correspond are red and green, and the additional color component that is generated by the mechanism is blue.

17. The optical scanning device of claim 16, wherein the optical sensors essentially consist of a first optical sensor corresponding to red, a second optical sensor corresponding to green, and a third optical sensor corresponding to grayscale.

18. An optical scanning device comprising:
a plurality of optical sensors corresponding to a plurality of color components of an image and to a grayscale component of the image; and,
means for generate an additional color component from the color components of the image and from the grayscale component of the image,
such that a full color digital representation of the image is acquirable.

19. The optical scanning device of claim 18, further comprising:
one or more white light sources to output white light against the image for detection by the optical sensors; and,
a mechanism to advance media having the image to be optically scanned in relation to the optical sensors.

20. The optical scanning device of claim 18, wherein the means generates the additional color component from the color components of the image and from the grayscale component of the image by subtracting values for the color components of the image from a product of a constant and a value for the grayscale component of the image.
